(19) United States
(12) Patent Application Publication
(10) Pub. No.: US 2005/0041279 A1
(43) Pub. Date: Feb. 24, 2005

(54) Hingeless mirror decice and method of controlling the same

(75) Inventor: Kiyoyuki Kawai, Higashikurume-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/920,445

(22) Filed: Aug. 18, 2004

(30) Foreign Application Priority Data
Aug. 22, 2003 (JP) 2003-298721

(51) Int. Cl. G02B 26/00

(52) U.S. Cl. 359/291

(57) ABSTRACT

A hingeless mirror device includes a conductor portion having electrical-conductivity for forming a closed spacing, a planar conductor mirror stored in the closed spacing, a plurality of electrodes mutually insulated and disposed on a conductor via an insulative substrate, a transparent electrode provided above an opening of the conductor, a power supply section which supplies voltages to the conductor and transparent electrode, and a control section which supplies control voltages to the plurality of electrodes, and which causes the closed spacing to generate an electrostatic force, thereby controlling a tilt angle of the conductor mirror. According to the hingeless mirror device, since the conductor portion is stabilized in potential, an unnecessary electrostatic force and the like do not occur, thereby enabling the control to be securely performed.

### CROSS-REFERENCE TO RELATED APPLICATIONS

This application is based upon and claims the benefit of priority from prior Japanese Patent Application No. 2003-298721, filed Aug. 22, 2003, the entire contents of which are incorporated herein by reference.

### BACKGROUND OF THE INVENTION

1. Field of the Invention

The present invention relates to a hingeless mirror device adaptable to, for example, a digital micromirror device, and a method of controlling such a hingeless mirror device.

2. Description of the Related Art

In recent years, digital micromirror devices (DMDs) have been used as spatial light modulators, wherein the angle of the micromirror controlled by using electrostatic forces. The DMD performs flexible control of the angle of a conductor mirror by using electrostatic forces occurring across a plurality of electrodes. Known are mirror devices of the type having the construction using a hinge, and mirror devices of the type that has no hinge portion in order to simplify the mechanical structure and so facilitate manufacture.

A hingeless mirror device of the latter type is disclosed in Patent Document 1 (Japanese Patent No. 3411014 (Jpn. Pat. Appln. KOKAI Publication No. 2002-139681)). The disclosed mirror device is not provided with a support mechanism such as a hinge, but is capable of controlling the angle of a conductor mirror only with electrostatic forces. Therefore, the device can be manufactured without requiring advanced manufacturing techniques.

The hingeless mirror device has a mirror, and the mirror is disposed within a closed spacing surrounded by partition walls, in which on/off control of, for example, output light can be performed. In an example, partition walls are formed of a dielectric. In this case, however, electric charge is likely to accumulate on the partition walls, whereby large electromotive forces causing the electric charge to adhere to the partition walls are generated, so that further improvement is demanded.

According to the prior art, the conductive micromirror is brought in some manner into contact with the dielectric portion that forms the closed spacing. At this time, some electric charges are accumulated in the dielectric portion, so that electrostatic forces occur between the charged dielectric portion and the micromirror conductor. In this event, since the contact portion between the dielectric portion and the conductive micromirror is very narrow, there occur intensive electrostatic forces different from originally contemplated electrostatic forces.

As a consequence, exceeding the original intention for causing the conductive micromirror to generate electromotive forces whereby the conductive micromirror is controlled, the intensive electrostatic forces make it difficult to control the micromirror conductor. In the worst case, there is a probability that the conductive micromirror is caused by the electrostatic forces to adhere to the dielectric portion. More specifically, in the mirror device according to the prior art, there occur unintended intensive electrostatic forces because of the contact of the conductive micromirror with the dielectric portion, making it difficult to perform control.

### BRIEF SUMMARY OF THE INVENTION

An embodiment of the present invention is a hingeless mirror device characterized by comprising: a conductor portion which is formed of a conductor having electrical-conductivity into a box-like shape, the conductor portion having openings formed on two surfaces opposite to each other, and having a closed spacing surrounded by the conductor; a planar conductor mirror disposed in the closed spacing; driving electrodes which are insulated and disposed on the side of one opening of the conductor portion and which are formed of first and second electrodes individually provided opposite each other in the closed spacing; a transparent electrode which is insulated and disposed apart by a predetermined distance on the side of the other opening of the conductor portion and which is provided to face the driving electrodes; a power supply section which supplies predetermined potentials to the transparent electrode and the conductor portion; and a control section which supplies binary control voltages individually to the first and second driving electrodes, and which causes the closed spacing to generate an electrostatic force, thereby controlling a tilt angle of the conductor mirror.

### BRIEF DESCRIPTION OF THE SEVERAL VIEWS OF THE DRAWING

FIG. 1 is a structural view showing an embodiment of a hingeless mirror device according to the present invention;

FIG. 2 is a plan view showing an example of the construction of a major portion of the hingeless mirror device according to the invention;

FIG. 3 is a plan view showing another example of the construction of the major portion of the hingeless mirror device according to the invention;

FIG. 4 is a plan view showing still another example of the construction of the major portion of the hingeless mirror device according to the invention;

FIG. 5 is a structural view showing another embodiment of a hingeless mirror device according to the present invention;

FIG. 6 is a structural view showing still another embodiment of a hingeless mirror device according to the present invention; and

FIG. 7 is a block diagram illustrative of example use of the hingeless mirror device according to the present invention.

### DETAILED DESCRIPTION OF THE INVENTION

A hingeless mirror device and a control method therefor according to an embodiment of the present invention will be described with reference to the accompanying drawings.

<Hingeless Mirror Device of the Invention>

(Construction)

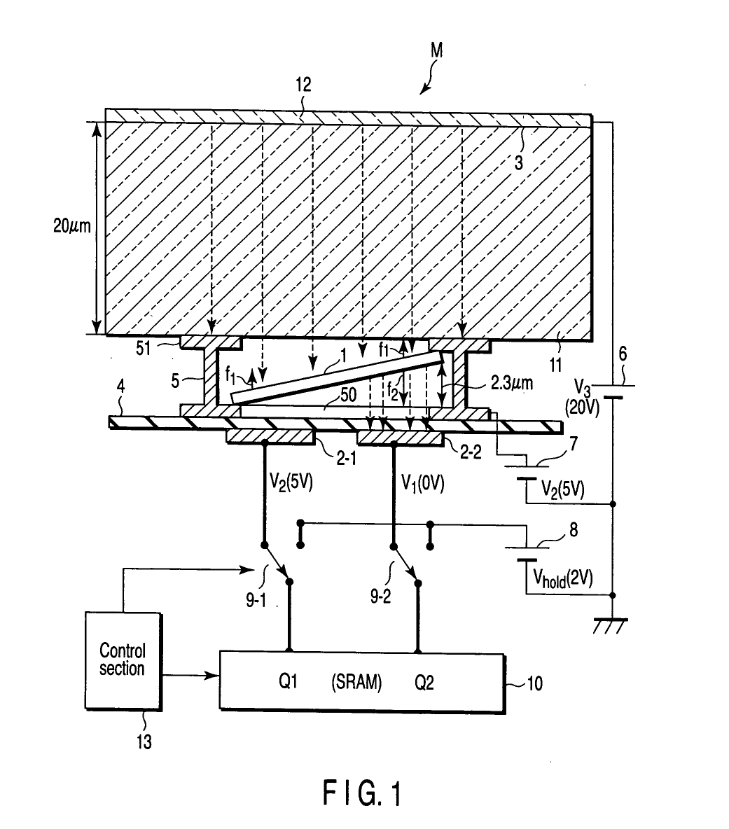

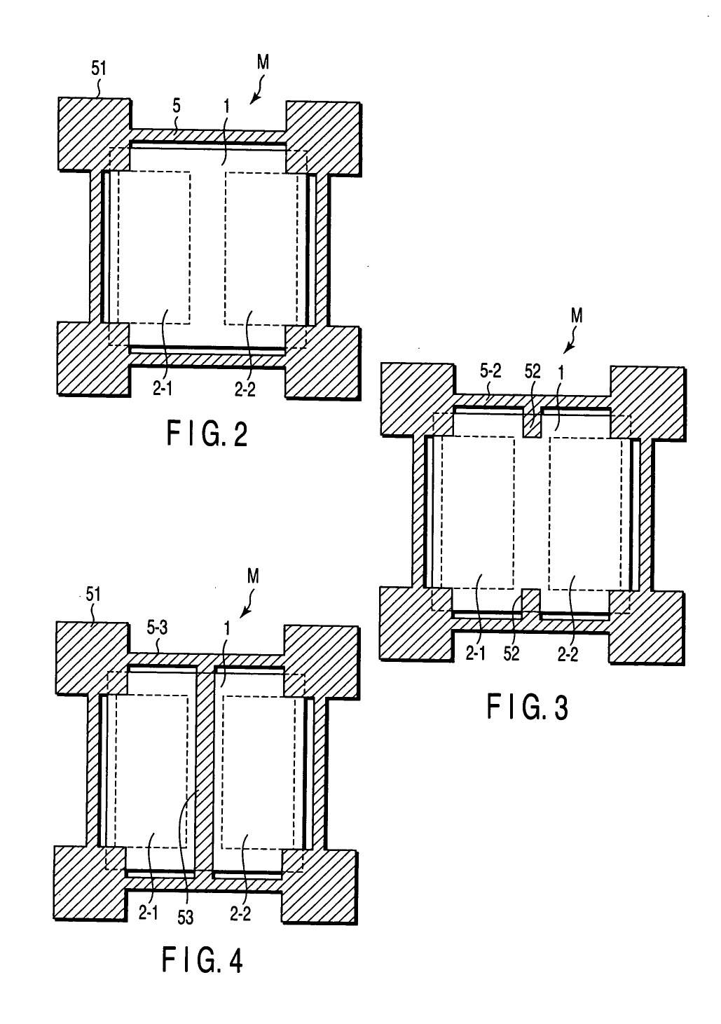

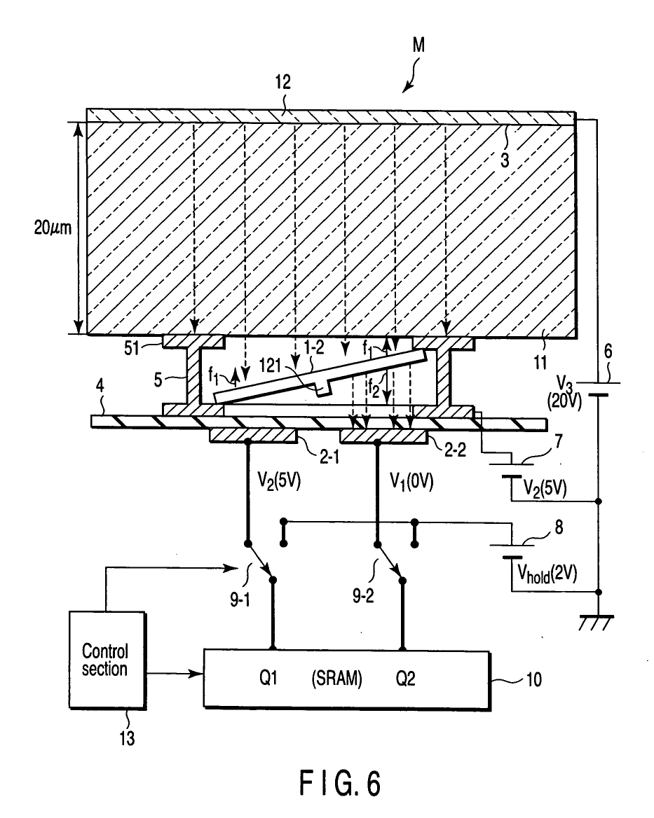

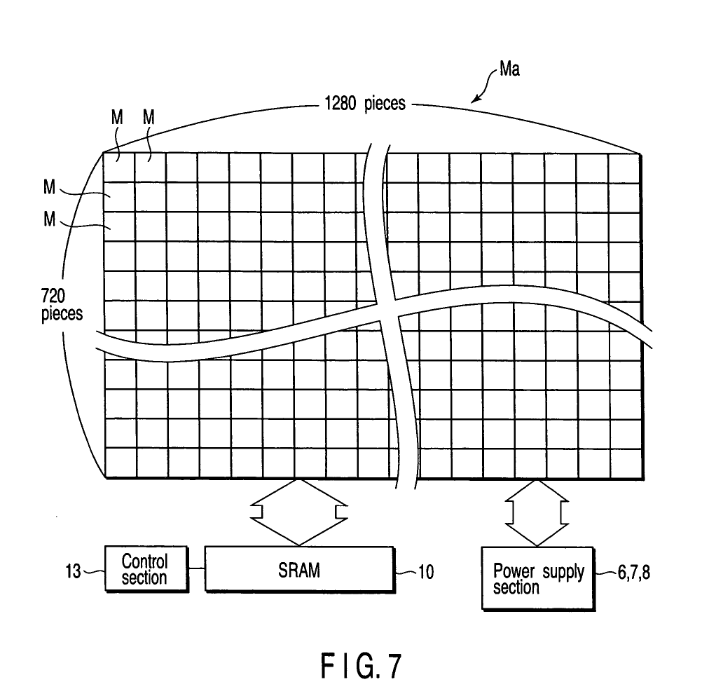

FIG. 1 is a structural view showing an example of a hingeless mirror device according to the present invention; FIG. 2 is a plan view showing an example of the construction of a conductor portion thereof; FIG. 3 is a plan view showing another example of the construction of the conductor portion thereof; FIG. 4 is still another example of the construction of the conductor portion thereof; FIG. 6 is a structural view showing an embodiment of a hingeless mirror device according to the present invention; and FIG. 7 is a block diagram illustrative of example use of the hingeless mirror device according to the present invention.

With reference to FIG. 1, an example of a hingeless mirror device according to the present invention will be described hereunder. The hingeless mirror device according to the present invention is constructed using a set of a plurality of mirror units M. An enlarged view of one of the mirror units M is shown in FIG. 1. The mirror unit M has a conductor portion 5 having electrical-conductivity. The conductor portion 5 is formed in such a manner that a conductor having electrical-conductivity is disposed squarely whereby to form a box-shaped closed spacing. Further, in the closed spacing there is stored a conductor mirror 1 shaped as a hingeless plate that does not have a support mechanism like a hinge. The closed spacing is formed in such a manner as to surround peripheral portions of the conductor mirror 1. The closed spacing has openings in upper and lower potions opposing the obverse surface and reverse surface of the conductor mirror 1, whereby the conductor mirror 1 is vertically movable in the closed spacing.

More specifically, the conductor portion 5 and the conductor mirror 1 have the relationship shown in the plan view of FIG. 2. Referring to FIG. 2, the conductor portion 5 is formed of a conductor having a square shape, in which the conductor mirror 1 is stored in the closed spacing surrounded by conductor walls. The conductor portion 5 thus formed has small gaps (air gaps) on contact sides of the conductor mirror 1 and the conductor portion 5. In a lower portion of the each closed spacing, an opening 50 slightly smaller than the outer shape of the conductor mirror 1 is provided. In an upper portion of the each closed spacing, a projection portion 51 is proved to prevent the conductor mirror 1 from being ejected out. The projection portion 51 is mounted on, for example, an insulation thin film 11 described below.

Referring again to FIG. 1, a pair of driving electrodes 2-1 and 2-2 are disposed in the lower projection portion 51 with an insulation layer 4 being interposed therebetween. A transparent electrode thin film 3 (which hereafter referred to as a “transparent electrode”) is insulated and spaced apart by a sufficient distance in opposition to the upper opening. In the present embodiment, the insulation thin film 11 is disposed in such a manner as to cover the upper opening of the conductor portion 5. A flat glass plate 12 is mounted on the insulation thin film 11, and the transparent electrode 3 is formed on the planar glass plate 12. The insulation thin film 11 insulates the transparent electrode 3 and serves as a position-setting spacer of the transparent electrode 3. A transparent polyimide or the like is used for the insulation thin film 11.

For example, referring to FIG. 1, when the movement amount of the conductor mirror is 2.3 μm, the transparent electrode 3 is disposed apart by a distance of 20 μm from the upper portion of the conductor portion 5. The transparent electrode 3 and the conductor portion 5 are coupled to external power supply sections 6 and 7 such that a fixed potential V3 (20V, for example) is imparted to the transparent electrode 3, and a fixed potential V2 (5V, for example) is imparted to the conductor portion 5.

The potentials of the electrodes 2-1 and 2-2 are switched by switches 9-1 and 9-2, respectively. The switches 9-1 and 9-2 can be selectively coupled to outputs Q1 and Q2 of a data holding circuit 10 or a fixed potential Vhold (2V, for example) supplied from a power supply section 8. Control of the switches 9-1 and 9-2 and the data holding circuit 10 is controlled by a control section 13. The outputs Q1 and Q2 of the data holding circuit 10 is alternately switched such that, when one of them becomes 0V, the other becomes 5V.

Accordingly, in a first mode, the switches 9-1 and 9-2 can select potentials V1 (0V, for example) and V2 (5V, for example) of the outputs Q1 and Q2, respectively, of the data holding circuit 10. In a second mode, the fixed potential Vhold supplied from the power supply section 8 (2V, for example) can be selected.

The data holding circuit 10 can easily be manufactured as a static random access memory (SRAM) by using a conventional semiconductor manufacturing process. That is, as a storage device, the data holding circuit 10 is preferably constructed of a semiconductor chip. Therefore, the hingeless mirror device of the present invention is manufactured in the following manner, for example. The external power supply sections 7 and 8, switches 9-1 and 9-2, and data holding circuit 10 are fabricated in a semiconductor chip; the driving electrodes 2-1 and 2-2 and insulation layer 4 are fabricated on the surface of the semiconductor chip; and the conductor portion 5 and conductor mirror 1 shaped as a hingeless plate are fabricated over the semiconductor chip. Further, the glass plate 12, on which the transparent electrode 3 is formed, is disposed via the insulation thin film 11 on the conductor portion 5 over the semiconductor chip, and the transparent electrode 3 is used as the external power supply section 6.

Preferably, construction elements other than the conductor mirror 1, particularly, the conductor portion 5 to be directly exposed to incident light is either constructed of a material having a low reflectance or surface-coated with a material having a low reflectance. This is because, since the construction elements other than the conductor mirror 1 are each fixed, when stray light is entrained by a light switch-off operation and even a slight quantity thereof is output as output light, the elements are not turned 100% off, thereby potentially leading to deterioration of the light switch-off performance.

(Operation)

Operation of the hingeless mirror device of the present invention having the above-described construction will now be described hereunder. First, it is assumed such that the potentials of the driving electrodes 2-1 and 2-2 are selected by the switches 9-1 and 9-2 from the potentials of the data holding circuit 10; and the potential of the electrode 2-1 is V2 (5V), and the potential of the electrode 2-2 is V1 (0V). In this state, the conductor mirror 1 comes into contact with the conductor portion 5, and secures a stable potential, specifically the potential V2 (5V). In addition, it is assumed that the transparent electrode 3 is disposed apart by a sufficient distance from the conductor mirror 1, in which substantially a uniform electric field is generated above the conductor mirror 1, and upward electrostatic forces f1 at substantially the same levels are generated on the electrode 2-1 side and electrode 2-2 side of the conductor mirror 1.

By way of example, in FIG. 1, with respect to the movement of the conductor mirror 1 in an amount of 2.3 μm, the transparent electrode 3 is spaced apart by a distance of 20 μm from the upper portion of the conductor portion 5. On the lower side of the conductor mirror 1, an electric field occurs between the conductor mirror 1 and the electrode 2-2, and an electrostatic force f2 occurs. Such an electric field and electrostatic force do not occur between the electrode 2-1 and the conductor mirror 1 as they have the same potential. The placement distances between the transparent electrode 3 and the electrode 2-1 and between the electrode 2-2 and the conductor mirror 1, and potentials V1, V2, and V3 are appropriately selected, whereby setting is made to satisfy the relationship “f2≈2×f1.” For example, although V1 and V2 are the same, when the spacing between the transparent electrode 3 and the conductor portion 5 is set to 100 μm, setting can be made to satisfy the relationship “f2≈2×f1” by controlling V3 to 100V. Thereby, the conductor mirror 1 receives a downward force (f2−f1≈f1) on the electrode 2-2 side, and receives an upward force (f1−0=f1) on the electrode 2-1 side, whereby the conductor mirror 1 is switched from the tilt shown in FIG. 1 to the reverse tilt.

(Operation Modes)

Operation will now be described below in units of two modes selected by the control of the control section 13. The control section 13 can select a normal operation mode as a first mode and a holding mode as a second mode.

First, in the first mode, the switches 9-1 and 9-2 are controlled by the control section 13 to select the potentials from the potentials of the data holding circuit 10. It is assumed that the potential of the potential of the electrode 2-2 is set to V1 (0V) and the electrode 2-1 is set to V2 (5V) according to the potential selection. The conductor mirror 1 comes into contact with the conductor portion 5 whereby to have the potential V2 (5V). On the upper side (mirror side) of the conductor portion 5, an electric field occurs between the portion and the transparent electrode 3, and substantially a uniform electric field is generated. Accordingly, the upward electrostatic forces f1 at substantially the same levels are generated on the electrode 2-1 side and electrode 2-2 side of the conductor mirror 1. On the other hand, an electric field occurs between the conductor mirror 1 and the electrode 2-2, the electrostatic force f2 is generated. Such an electric field and electrostatic force do not occur between the electrode 2-1 and the conductor mirror 1 as they have the same potential (V2=5V). Accordingly, the conductor mirror 1 receives a downward force “f2−f1≈f1” on the electrode 2-1 side. On the other hand, the conductor mirror 1 receives an upward force “f1−0=f1” on the electrode 2-2 side. Thereby, the conductor mirror 1 is stabilized at the tilt shown in FIG. 1. In contrast, the conductor mirror 1 is tilted in the reverse direction when the potential of the electrode 2-1 becomes 0V and the potential of the electrode 2-1 becomes 5V.

In the above description, while description has been made referring to the case where the potentials are positive, similar operation is accomplished even when the potentials are negative. The distance between the transparent electrode 3 and the conductor mirror 1 is set to be sufficiently large with respect to the movement amount of the conductor mirror 1. The relationship between the individual potentials in this case is expressed as “|V1|<|V2|<|V3|”.

Alternatively, V1 and V2 may be set to potentials with the same sign and only V3 may be set to a potential with a different sign to be set to “|V1|<|V2|<|V3−V2|”.

The second mode, that is, the holding mode, will be described hereunder. In this mode, the switches 9-1 and 9-2 are switched to select the fixed potential Vhold, whereby the fixed potential Vhold from the power supply section 8 is supplied to the driving electrodes 2-1 and 2-2. At this time, the conductor mirror 1 comes into contact with the conductor portion 5 and hence becomes the potential V2 (5V). Suppose that Vhold is set to cause the electric field intensity on the lower side of the conductor mirror 1 to be substantially the same as the electric field intensity on the upper side of the conductor mirror 1. In this case, since the conductor mirror 1 is in a tilted state, a downward electrostatic force slightly higher than f1 occurs on the electrode 2-1 side, and an electrostatic force slightly lower than f1 occurs on the electrode 2-2 side. Thereby, mechanical latching operation can be performed to maintain the tilt of the conductor mirror 1 to the previous state. Thus, setting the driving electrodes 2-1 and 2-2 to Vhold enables mechanical latching to be implemented, whereby data in the data holding circuit 10 can be arbitrarily rewritten (reprogrammed) while the tilt of the conductor mirror 1 is being maintained.

Accordingly, the conductor mirror 1 can be controlled to tilt positions corresponding to the data in the data holding circuit 10 in such a manner that the switches 9-1 and 9-2 are switched to switch the mode to the first mode after the data in the data holding circuit 10 is reprogrammed in the second mode.

The relationship between the individual potentials is set to satisfy V1<Vhold<V2<V3. While the embodiment has been described referring to the case where the potentials are positive, similar operation is accomplished even when the potentials are negative. Accordingly, the relationship between the individual potentials is expressed as |V1|<|Vhold|<|V2|<|V3|. Alternatively, V1, V2, and Vhold may be set to potentials with the same sign and only V3 may be set to a potential with a different sign. In this case, the relationship can be expressed as |V1|<|Vhold|<|V2|<|V3−V2|.

As described above, in the conductor mirror device of the present invention, the conductor mirror 1 is stored in the closed spacing that is formed in the conductor portion 5 having electrical-conductivity and being imparted with the stable potential. Consequently, no instance takes place in which the conductor mirror 1 comes into direct contact with the dielectric. The stable potential is forcibly imparted from the external power supply sections to any of the closed spacing, conductor mirror 1, driving electrodes 2-1 and 2-2, and transparent electrode. Accordingly, in the hingeless mirror device of the present invention, different from the prior art, the drawback of the prior art in which the conductor mirror 1 and the dielectric material are brought into direct contact with each other can be avoided, and the angle of the conductor mirror 1 can be steadily controlled.

(Other Embodiments)

FIGS. 3 and 4 individual show other embodiments of hingeless mirror devices according to the present invention. The embodiments are each imparted with the property of reducing the contact area between the conductor portion 5 and the conductor mirror 1. As the area of contact portions between the conductor portion 5 and the conductor mirror 1 increases, the surface force is facilitated to occur.

In view of this fact, a conductor portion 5-2 shown in FIG. 3 has mutually opposite protruding portions 52 substantially in central portions of the conductor mirror 1, more specifically, in the position corresponding to the position between two electrodes 2-1 and 2-2. Thereby, the contact area is reduced.

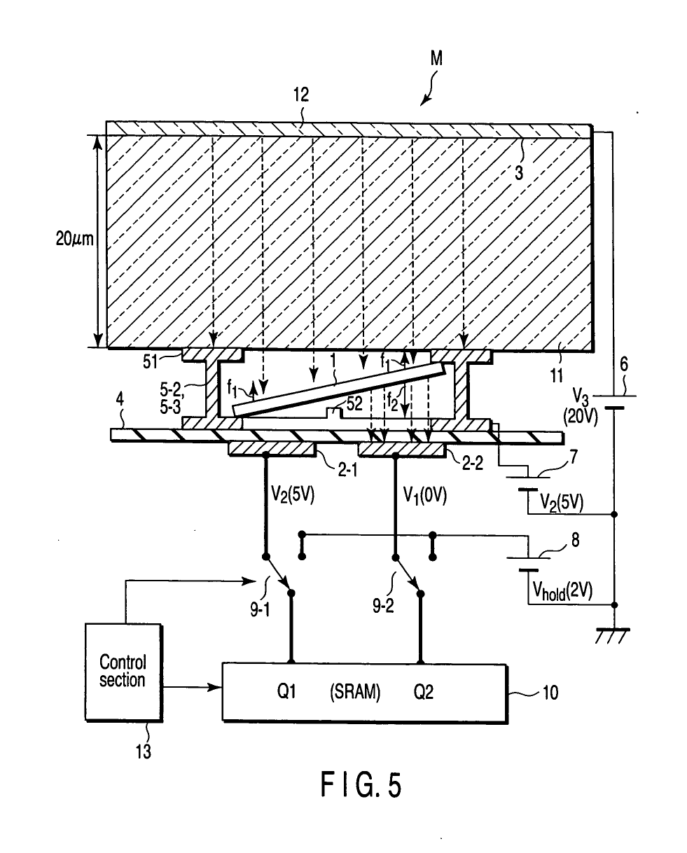

A conductor portion 5-3 shown in FIG. 4 has a protruding portion 53 of such a type as connecting the protruding portions 52 and 52 shown in FIG. 3, whereby to avoid adhesion between a surface of the conductor mirror 1 and a surface of a lower member of the protruding portion 53. This enables smooth control of the angle of the conductor mirror 1. FIG. 5 is illustrative of an example using either of the conductor portions shown in FIGS. 3 and 4.

Further, in an example shown in FIG. 6, a protruding portion 121 is provided on the side of a conductor mirror 1-2, thereby avoiding adhesion between a surface of the conductor mirror 1-2 and a surface of the conductor mirror 5, similar to the above-described embodiment. Thereby, the angle of the conductor mirror 1 can be steadily controlled, similar to the example described above.

(Embodiment as Light Quantity Control Device)

As described above, according to the hingeless mirror device of the present invention, the mirror reflection light can be controlled by controlling the tilt of the conductor mirror 1. More specifically, incident light is obliquely input through the transparent electrode to cause the reflected light of the conductor mirror 1 to travel along a normal of the transparent electrode. At this time, on-operation takes place as the operation of optical switching. When the conductor mirror 1 is controlled to the reverse tilt, the reflected light is output at a double angle with respect to the incident angle in the opposite direction to that of the incident angle, and the reflected light is discarded as unnecessary light. At this time, off-operation takes place as the operation of optical switching.

Thus, on/off operations as described above are iteratively performed within a unit time at a predetermined rate according to the operation of the control section 13. Thereby, in response to a signal value such as an analog value or digital value provided from the outside, mirror reflection light corresponding to the signal value can be obtained. For example, suppose that control voltages are generated by the control section 13 so that on-operations are performed by 30% in a predetermined time and off-operations are performed by 70% in the predetermined time, and the control voltages is applied to the driving electrodes 2-1 and 2-2. In this case, light having about 30% brightness can be output. In this manner., according to the hingeless mirror device of the present invention, tonal representation can be performed by controlling the mirror reflection light.

FIG. 7 is illustrative of example use of the hingeless mirror device described above. According to the example, a hingeless mirror device Ma is formed by disposing a plurality of mirror units M (vertically 720 pieces and horizontally 1280 pieces, for example) in the form of a matrix, and the control section 13, SRAM 10, and power supply sections 6, 7, and 8 are provided for the hingeless mirror device Ma. Thereby, for example, a projector can be used.

More specifically, light from a light source (not shown) is emitted to the hingeless mirror device Ma, the individual mirror units M are on/off-controlled corresponding to the brightness represented by a video signal, and reflected light from the individual mirror units M is projected onto a screen, whereby imagery can be displayed thereon. Further, color imagery can be displayed in the manner that R (red), G (green), and B (blue) rays of light are sequentially time-divisionally emitted to the hingeless mirror device Ma, the individual mirror units M are on/off-controlled responsively to individual R, G, and B video outputs, and reflected light is then projected onto a screen.

The present invention is not limited to the embodiments described above, and other modifications and alterations may be made.

1. A hingeless mirror device comprising:
a conductor portion which is formed of a conductor having electrical-conductivity into a box-like shape, the conductor portion having openings formed on two surfaces opposite to each other, and having a closed spacing surrounded by the conductor;
a planar conductor mirror disposed in the closed spacing;
driving electrodes which are insulated and disposed on the side of one opening of the conductor portion and which are formed of first and second electrodes individually provided opposite each other in the closed spacing;
a transparent electrode which is insulated and disposed apart by a predetermined distance on the side of the other opening of the conductor portion and which is provided to face the driving electrodes;
a power supply section which supplies predetermined potentials to the transparent electrode and the conductor portion; and
a control section which supplies binary control voltages individually to the first and second driving electrodes, and which causes the closed spacing to generate an electrostatic force, thereby controlling a tilt angle of the conductor mirror.

2. A hingeless mirror device according to claim 1, wherein, when the potential to be supplied from the power supply section to the transparent electrode is V3 and the potential to be supplied from the power supply section to the conductor portion is V2, the control section selectively supplies the potential V2 and a potential V1 to the first and second electrodes, wherein the individual potentials are related as |V1|<|V2|<|V3|.

3. A hingeless mirror device according to claim 1, wherein
the power supply section is capable of supplying a predetermined holding potential Vhold to the first and second electrodes,
the control section is capable of switching between a first mode and a second mode, wherein the first mode selectively switches between the potentials V2 and V1 and thereby supplies the potentials V2 and V1 to the first and second electrodes, and the second mode commonly supplies the holding potential Vhold from the power supply section to the first and second electrodes, and
the individual potentials are related as |V1|<|Vhold|<|V2|, and the tilt angle of the conductor mirror is held in the second mode.

4. A hingeless mirror device according to claim 1, wherein the control section supplies the control voltages to the first and second electrodes by using a data holding circuit.

5. A hingeless mirror device according to claim 1, wherein the control section supplies the binary control voltages individually to the first and second driving electrodes and controls a reflection state associated with the conductor mirror in response to the control voltages such that on/off operations of the conductor mirror are iteratively performed within a unit time at a predetermined rate.

6. A hingeless mirror device according to claim 1, wherein the conductor mirror disposed in the closed spacing in the conductor portion has a shape larger than the one opening, and a projection portion is provided in the conductor portion so as to prevent the conductor mirror from being ejected out from the other opening.

7. A hingeless mirror device according to claim 1, wherein, on a surface on the side of the one opening, the conductor mirror has a protruding portion in a position corresponding to a position between the first and second electrodes to thereby prevent a surface of the conductor mirror from adhering to a surface of the conductor portion.

8. A hingeless mirror device according to claim 1, wherein, on the side of an inner surface of the one opening, the conductor mirror has a protruding portion in a position corresponding to a position between the first and second electrodes to thereby prevent a surface of the conductor mirror from adhering to a surface of the conductor portion.

9. A hingeless mirror device according to claim 1, wherein the first and second electrodes are provided opposite each other in the closed spacing via a first insulator disposed in such a manner as to cover the one opening of the conductor portion.

10. A hingeless mirror device according to claim 1, wherein the transparent electrode is provided to face the driving electrodes via a transparent second insulator disposed in such a manner as to cover the other opening of the conductor portion.

11. A hingeless mirror device according to claim 1, wherein the transparent electrode is formed on a glass plate mounted on the second insulator.

12. A hingeless mirror device according to claim 1, wherein the conductor portion is configured of a conductor formed in a square state to form a plurality of closed spacings in the form of a matrix, and the conductor mirror is disposed in each of said plurality of closed spacings.

13. A hingeless mirror device comprising:
a conductor portion which is formed of a conductor having electrical-conductivity into a box-like shape, the conductor portion having openings formed on two surfaces opposite to each other, and having a closed spacing surrounded by the conductor;
a planar conductor mirror disposed in the closed spacing;
driving electrodes which are insulated and disposed on the side of one opening of the conductor portion and which are formed of first and second electrodes individually provided opposite each other in the closed spacing;
a transparent electrode which is insulated and disposed apart by a predetermined distance on the side of the other opening of the conductor portion and which is provided to face the driving electrodes;
a power supply section which supplies a potential V3 to the transparent electrode and a potential V2 to the conductor portion; and
a control section which selectively switches between the individual potentials to be |V1|<|V2|<|V3| and thereby supplies the potentials V2 and V1 to the first and second electrodes, and which causes the closed spacing to generate an electrostatic force, thereby controlling a tilt angle of the conductor mirror.

14. A hingeless mirror device comprising:
a conductor portion which is formed of a conductor having electrical-conductivity into a box-like shape, the conductor portion having openings formed on two surfaces opposite to each other, and having a closed spacing surrounded by the conductor;
a planar conductor mirror disposed in the closed spacing;
driving electrodes which are insulated and disposed on the side of one opening of the conductor portion and which are formed of first and second electrodes individually provided opposite each other in the closed spacing;
a transparent electrode which is insulated and disposed apart by a predetermined distance on the side of the other opening of the conductor portion and which is provided to face the driving electrodes;
a power supply section which supplies a potential V3 to the transparent electrode and a potential V2 to the conductor portion; and
a control section having a first mode and a second mode, wherein the first mode selectively switches between the potentials V2 and V1 to be |V1|<|Vhold|<|V2|<|V3| and thereby supplies the potentials V2 and V1 to the first and second electrodes, and the second mode commonly supplies a predetermined potential Vhold from the power supply section to the first and second electrodes, the control section causing the closed spacing to generate an electrostatic force to thereby control a tilt angle of the conductor mirror.

15. A method of controlling a hingeless mirror device, comprising:
storing a conductor mirror into a closed spacing surrounded by a conductor in a conductor portion which is formed of a conductor having electrical-conductivity into a box-like shape and which has openings formed on two surfaces opposite to each other;
providing driving electrodes which are formed of first and second electrodes individually provided opposite each other on the side of one opening of the conductor portion, and providing a transparent electrode to be apart by a predetermined distance on the side of the other opening of the conductor portion to face the driving electrodes; and
supplying predetermined potentials to the transparent electrode and the conductor portion, and supplying binary control voltages individually to the first and second driving electrodes, whereby causing the closed spacing to generate an electrostatic force to thereby control a tilt angle of the conductor mirror.
